(19) United States
(12) Patent Application Publication
(10) Pub. No.: US 2026/0214107 A1
(43) Pub. Date: Jul. 23, 2026

(54) Anomaly Detection in Cloud Operations Using Artificial Intelligence

(71) Applicant: Samsung Electronics Company, Ltd., SUWON SI (KR)

(72) Inventor: Rama Syamala Sreepada, Vancouver (CA)

(21) Appl. No.: 19/028,259

(22) Filed: Jan. 17, 2025

(51) Int. Cl. H04L 9/40; G06F 21/55

(52) U.S. Cl. CPC H04L 63/1425; G06F 21/554

(57) ABSTRACT

In one embodiment, a method includes accessing logs associated with a cloud computing system, detecting abnormal events associated with the cloud computing system based on the logs by machine-learning models, identifying logs that are associated with the abnormal events, determining a respective time period and a respective severity associated with each of the abnormal events based on the logs by the machine-learning models, generating an alert including an aggregation of the abnormal events, each abnormal event being associated with the respective time period and the respective severity, and sending instructions for presenting the alert to a user device.

### TECHNICAL FIELD

This disclosure generally relates to cloud computing systems, and in particular relates to hardware and software for anomaly detection in cloud computing systems.

### BACKGROUND

Cloud-based applications are essential for businesses today, providing flexibility, scalability, and cost savings. The growing complexity of modern IT cloud infrastructure and the increasing volume of data and businesses warrant an effective artificial intelligence operations (AIOps) platform. Cloud environments often consist of numerous interconnected components, such as servers, databases, networks, and applications, which produce massive amounts of data. Analyzing and managing this data manually in real-time can be challenging and error-prone. The AIOps platform would help operations by overcoming cloud infrastructure challenges, such as an increase in resource expenditure and performance issues, including outages.

AIOps is a powerful tool for enhancing cloud operations by automating many aspects of IT management, improving efficiency, and reducing downtime. Its real-time capabilities allow IT teams to detect and respond to issues promptly, while its advanced analytics, automation, integration, and reporting features provide valuable insights and support informed decision-making. As the complexity of IT infrastructures continues to increase, AIOps will become even more essential for organizations looking to maintain high levels of service quality and stay ahead of the competition.

### BRIEF DESCRIPTION OF THE DRAWINGS

FIG. 1 illustrates an example architecture of the disclosed AIOps system.

FIG. 2 illustrates example issues for two events.

FIG. 3 illustrates an example estimation of ground truth.

FIG. 4 illustrates is a flow diagram of a method for anomaly detection in a cloud computing system, in accordance with the presently disclosed embodiments.

FIG. 5 illustrates an example computer system that may be utilized for determining sensing and communication precoders, in accordance with the presently disclosed embodiments.

### DESCRIPTION OF EXAMPLE EMBODIMENTS

### Anomaly Detection in Cloud Operations Using Artificial Intelligence

While some existing AIOps platforms may perform anomaly detection, there are several limitations, including a lack of a comprehensive model that provides the overall health of the system along with in-depth issue identification, ground truth estimation, and unsupervised model evaluation. The traditional systems may provide specific issues without the overall health of the log source. This could be overwhelming as the operations team may not know which issue or log source needs to be prioritized for resolution. The traditional systems may provide alerts based on static thresholding, without considering trend and seasonality in the data, thereby increasing false positive alerts and lacking interpretability. In addition, cloud computing systems may have limited real-time incidents, and it can be common to observe a higher number of false positives due to a lack of ground truth and model evaluation. This may put an extra workload on the support and operations team to go through each triggered anomaly. To mitigate these limitations, the embodiments disclosed herein use a novel feature engineering approach to quantify the severity of anomalous log sources to help with prioritization. The embodiments disclosed herein may also identify issues by incorporating trend and seasonality in the data and provide expected range, improving accuracy and interpretability.

In particular embodiments, the AIOps system may detect anomalies using defined features such as the number of issues per time period, grouped by status code, statistical information, etc. The AIOps system may also provide an anomaly severity score and estimated non-anomalous data distributions for the IT support team to prioritize investigations. The AIOps system may be hierarchical, where the topmost layer can provide individual anomalous patterns, along with probable issues. The bottom layers can provide a summary of anomalous time periods of each log source, along with anomaly severity scores. To retain the low latencies in identifying anomalies, the AIOps system may use a novel feature engineering approach to identify anomalous time periods. Evaluating an AIOps system can be challenging due to the unavailability of sufficient real incidents and the availability of ground truth. The AIOps system can use a simple yet novel ground-truth estimator to quantify the efficiency of the AIOps system. The AIOps system may have a variety of features. For example, anomaly detection of the AIOps system may proactively identify unusual behavior in the IT environment, thereby enabling quick resolution of potential issues. As another example, the adaptability to learn and adapt to changes in the IT environment may ensure continued effectiveness over time. As yet another example, the AIOps system can be based on a generalized, scalable, and flexible framework, which can be adapted to any cloud application and support the dynamic needs of the cloud applications. Although this disclosure describes detecting particular anomalies by particular systems in a particular manner, this disclosure contemplates detecting any suitable anomaly by any suitable system in any suitable manner.

In particular embodiments, the AIOps system may access a plurality of logs associated with a cloud computing system. The AIOps system may then detect, based on the plurality of logs by one or more machine-learning models, a plurality of abnormal events associated with the cloud computing system. The AIOps system may identify one or more logs among the plurality of logs that are associated with the plurality of abnormal events. The AIOps system may further determine, based on the one or more logs by the one or more machine-learning models, a respective time period and a respective severity associated with each of the plurality of abnormal events. The AIOps system may then generate an alert comprising an aggregation of the plurality of abnormal events, each abnormal event being associated with the respective time period and the respective severity. In particular embodiments, the AIOps system may send, to a user device, instructions for presenting the alert.

Certain technical challenges exist for detecting anomalies in a cloud computing system. One technical challenge may include accurate anomaly detection. The solution presented by the embodiments disclosed herein to address this challenge may be using machine learning and time-series algorithms to analyze trend and seasonality in time series, as the analysis of trend and seasonality may help reduce false positive alerts and improve interpretability for anomaly detection. Another technical challenge may include obtaining ground truth that categorizes anomalous versus non-anomalous events to quantify the performance of the AIOps system. The solution presented by the embodiments disclosed herein to address this challenge may be estimating ground truth from existing data distributions and historical incidents as historical data distribution of each event is observed and compared against the values during the real-incident history, thereby providing a statistical technique to estimate ground truth.

Certain embodiments disclosed herein may provide one or more technical advantages. A technical advantage of the embodiments may include real-time data ingestion, as the AIOps system can process and analyze data from multiple sources in real-time, including logs, metrics, and events. Another technical advantage of the embodiments may include aggregation of multiple levels of anomalies including issue identification, which may result in a faster resolution of the anomalies. Another technical advantage of the embodiments may include root cause analysis, which is the capability to traverse multiple log sources to pinpoint the underlying causes of anomalies, helping IT teams understand the source of the problem and take appropriate actions. Certain embodiments disclosed herein may provide none, some, or all of the above technical advantages. One or more other technical advantages may be readily apparent to one skilled in the art in view of the figures, descriptions, and claims of the present disclosure.

A cloud-based computing system is a type of computing infrastructure where resources are shared across multiple users and devices via the Internet, providing scalable and cost-effective solutions. The cloud-based computing system may include different types of servers, including web servers, application servers, and database servers, which host various services and data. These servers may maintain log files that record important information such as user requests, system events, and error messages, allowing administrators to monitor and troubleshoot the system effectively. The logs generated by the cloud-based computing system may help maintain the overall health and performance of the infrastructure.

Based on the type of application, various logs such as access, tomcat, load balancer, and infrastructure logs may be created. Each log type may have information such as HTTP request status, HTTP method, and the application endpoint call, response time, and response bytes, along with source, destination, or load balancer IP addresses. Infrastructure logs may store information about CPU and memory utilization, network throughput, and latency of the system. For the smooth functioning of the application, it can be important to swiftly identify any anomalous behavior in the system. Additionally, it can be also important to identify potential sources of the anomaly.

AIOps systems can be adopted to effectively utilize this information and identify anomalous time periods for a quick resolution in the application. The AIOps system disclosed herein may have the following functions. The AIOps system can identify anomalous events (such as unusual endpoint call count, abnormal response time, or bytes) in each log source. The AIOps system can also identify anomalous periods for each log source, along with the anomaly severity score. The AIOps system can further estimate ground truth and iteratively perform evaluation to result in improvements for the AIOps system.

In particular embodiments, the disclosed AIOps system may use a near-real-time AIOps anomaly detection model to ingest various log sources and infrastructure metrics to analyze and identify anomalous time periods, along with probable causes. As a result, the embodiments disclosed herein may have a technical advantage of real-time data ingestion, as the AIOps system can process and analyze data from multiple sources in real-time, including logs, metrics, and events. In particular embodiments, the AIOps system may determine, based on the identified logs by the machine-learning models, a respective cause associated with each abnormal event. Accordingly, the alert may further include the respective cause associated with each abnormal event. As a result, the embodiments disclosed herein may have a technical advantage of root cause analysis, which is the capability to traverse multiple log sources to pinpoint the underlying causes of anomalies, helping IT teams understand the source of the problem and take appropriate actions.

The AIOps system disclosed herein may have the following features. One feature may include flexibility. In an AIOps system, flexibility may refer to the capability of adapting to changes in business needs and handling diverse types of data. Flexibility may allow the system to easily incorporate new sources of data, modify existing algorithms, and adjust to evolving requirements. The cloud-based applications can be dynamic in nature. Therefore, there could be new API endpoints added with each version release, while some of the endpoints could be deprecated. The disclosed AIOps system may incorporate these changes without manual interventions and remain relevant and effective over time.

Another feature may include scalability. Scalability may be important for an AIOps system to handle increasing volumes of data without experiencing performance degradation. With a growing business, the disclosed AIOps system may have the capability to handle new traffic without compromising the efficiency of the system.

Another feature may include extensibility. Extensibility may allow the disclosed AIOps system to integrate seamlessly with other interdependent applications and additional log sources without impacting its accuracy.

Another feature may include explainability. Explainability may be important in building trust and confidence in the anomalies alerted by the disclosed AIOps system. By providing clear insights into how the system arrives at its decisions, explainability can help users understand the underlying logic and reasoning behind the predictions, which may promote transparency and facilitate better decision-making.

Another feature may include early anomaly detection. Early anomaly detection may enable organizations to identify potential issues before they escalate into major disruptions. By analyzing patterns and trends in real-time data, the disclosed AIOps system can proactively flag anomalies and trigger alerts, allowing IT teams to take corrective actions promptly and ensure high availability of services.

Another feature may include ground truth estimation and evaluation. The disclosed AIOps system may be a closed-loop system where incident-based ground truth can be utilized to evaluate and finetune the system as and when the accuracy drops.

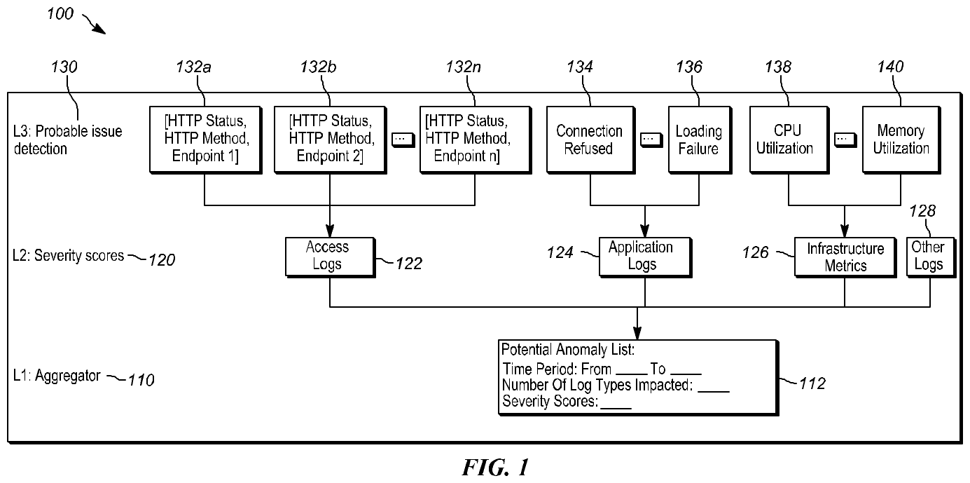

FIG. 1 illustrates an example architecture 100 of the disclosed AIOps system. The disclosed AIOps system may have the following levels. In particular embodiments, the disclosed AIOps system may have an L3 level 130, which focuses on detecting probable issues and providing details about each identified issue. The AIOps system may also have an L2 level 120, which focuses on determining severity scores for each abnormal event based on the logs and metrics associated with the abnormal event. The AIOps system may further have an L1 level 110, which includes an aggregator for all the detected abnormal events and their severity scores.

Each event in L3 level 130 may be defined based on the information available in the logs. The events may be from application logs 124. For example, such events may include connection refused 134 and loading failure 136. CPU utilization 138, memory availability 140, and network interface utilization, etc. may be the events from infrastructure metrics 126. There can be also other logs 128. For each such event, the values are aggregated on a minute-wise basis. On the other hand, events 132 in the access logs 122 may be defined based on the unique combination of HTTP status rounded off (200/400/500, etc.), HTTP method (POST/GET/PUT/GET/HEAD/DELETE, etc.), and application endpoint. For instance, an event could be [200, POST, verify], where verify is the application endpoint.

In particular embodiments, the AIOps system may identify a plurality of events associated with the plurality of logs. The AIOps system may then determine, for each of the identified events, one or more outcomes comprising one or more of a number of actions, total time, or a total byte transmitted, an infrastructure metric, or a connection error. The AIOps system may further generate a plurality of features for each of the outcomes associated with each identified event. Accordingly, detecting the plurality of abnormal events may be further based on the plurality of features associated with each of the outcomes associated with each identified event.

For each such event, the log outcomes, including the number of actions, total time, and total bytes transmitted, may be aggregated per minute. Some of the log types (e.g., a load balancer) may have more information such as received bytes, sent bytes, request processing time, response processing time, etc. Based on the availability, these outcomes may also be aggregated on a minute basis, as shown in Table 1.

TABLE 1
Number of calls per event every minute in access logs

| | 200-GET- | 200-POST- | 200-GET- | 200-POST- | 400-POST- | 500-POST- |
|---|---|---|---|---|---|---|
| Timestamp | Endpoint1 | Endpoint1 | Endpoint2 | Endpoint2 | Endpoint2 | Endpoint2 |
| 2024 Jun. 1 | 48,594 | 44,791 | 3,534 | 66,869 | 0 | 3 |
| 0:00 | | | | | | |
| 2024 Jun. 1 | 23,414 | 94,231 | 83,508 | 79,606 | 3 | 2 |
| 0:01 | | | | | | |
| 2024 Jun. 1 | 55,360 | 97,963 | 56,060 | 51,267 | 4 | 3 |
| 0:02 | | | | | | |
| 2024 Jun. 1 | 60,191 | 82,315 | 61,313 | 15,739 | 9 | 2 |
| 0:03 | | | | | | |
| 2024 Jun. 1 | 98,721 | 54,413 | 31,670 | 6,978 | 0 | 3 |
| 0:04 | | | | | | |
| 2024 Jun. 1 | 24,537 | 84,568 | 5,699 | 3,175 | 1 | 1 |
| 0:05 | | | | | | |
| 2024 Jun. 1 | 79,687 | 12,637 | 64,575 | 66,891 | 1 | 5 |
| 0:06 | | | | | | |
| . . . | | | | | | |
| 2024 Jun. 1 | 32,588 | 8,061 | 72,613 | 58,526 | 4 | 3 |
| 23:59 | | | | | | |

As illustrated in FIG. 1, aggregation 112 at L1 level 110 may include a potential anomaly list. The potential anomaly list may include the time period for each abnormal event, the number of logs and the log types being impacted, and the severity scores for all the abnormal events. As a result, the embodiments disclosed herein may have a technical advantage of aggregation of multiple levels of anomalies including issue identification, which may result in a faster resolution of the anomalies.

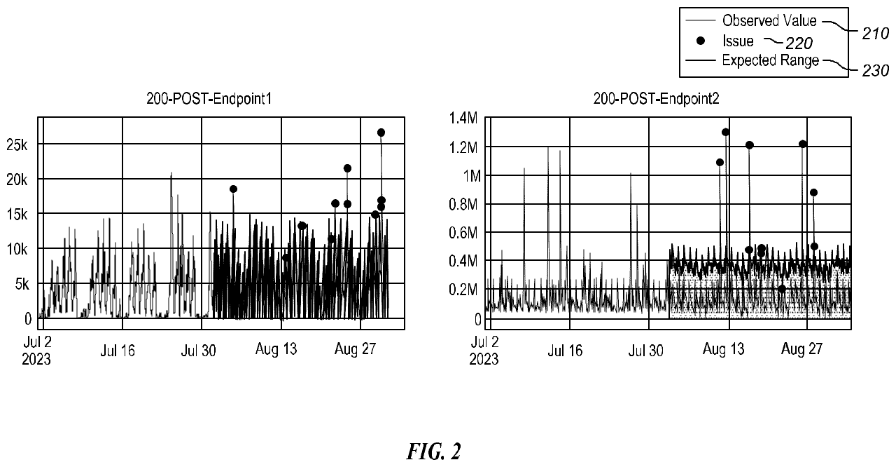

FIG. 2 illustrates example issues for two events. The two events include 200-POST-Endpoint1 and 200-POST-Endpoint2. As shown in FIG. 2, each event may have observed values 210, issues 220, and an expected range 230.

In particular embodiments, the model training and prediction at the L3 level 130 may be as follows. Each event may be considered as a time series. An additive regression model with a piecewise linear or logistic growth curve trend may be used to train each series separately. For example, 15 prior days of minute-wise data may be used to predict the upper and lower bound of expected values for the consecutive day. At time period t, if the observed value lies outside of the upper and lower bound, the event may be defined as an issue @time t.

In particular embodiments, the AIOps system may identify a plurality of events associated with the plurality of logs, wherein each of the identified events comprises a time series. The AIOps system may then determine, for each of the identified events, a trend and a seasonality associated with the time series, wherein the seasonality indicates a recurring pattern. Accordingly, detecting the plurality of abnormal events may be further based on the trend and seasonality associated with each of the identified events. Using machine learning and time-series algorithms to analyze trends and seasonality in time series may be an effective solution for addressing the technical challenge of accurate anomaly detection as the analysis of trends and seasonality may help reduce false positive alerts and improve interpretability for anomaly detection.

As illustrated in FIG. 1, the disclosed AIOps system may have an L2 level 120. Though the L3 level 130 can provide event-level issues, it is important to know if the time period has been anomalous for the entire log source, including the severity of the anomaly. For instance, a time period may be more anomalous if there are multiple events with issues that significantly deviate from the expected ranges. It is also important to quantify the overall health when some outcomes are more severe compared to other outcomes. Therefore, the L2 level 120 may be used to identify if the log source is anomalous and provide a severity score for each anomalous time period per log source.

In particular embodiments, the AIOps system may generate, based on the time periods and severities associated with the plurality of abnormal events, one or more anomalous log seventies for the one or more logs, respectively. The alert may further include the one or more anomalous log severities for the one or more logs, respectively.

To train an anomaly detection model with the right information, feature engineering may be utilized to differentiate between different types of issues observed from the L3 level 130. It is important to understand how many HTTP status codes (or infrastructure metrics) have abnormal activity, and statistics based on the deviation of the observed values and expected range (computed from the L3 level 130). Based on the defined features, the list of features is shown in Table 2. These feature values may be computed for each outcome per log type. As discussed previously, these outcomes could be a number of events, total time, total bytes, infrastructure metrics, connection errors, etc., dependent on the log sources used in developing the AIOps system.

TABLE 2
Features (Fₜ) defined per outcome, and time t in L2 level.

| Feature name | Acronym | Description |
|---|---|---|
| Number of issues observed at | \|Issues_G(t)\| | If \|Issues_G(t)\| is higher, there |
| time t, where the observed | | is a higher chance that time t is |
| value is greater than expected | | an anomaly. |
| range. | | |
| Number of issues observed at | \|Issues_G(t-1)\| | If both \|Issues_G(t-1)\| and |
| time t-1, where the observed | | \|Issues_G(t)\| are high, the |
| value is greater than expected | | chance of time t being an |
| range. | | anomaly increases. |
| Number of common issues | \| Issues_G(t) ∩ Issues_G(t-1)\| | If the number of common |
| between t and t-1, where the | | issues between t and t-1 times |
| observed value is greater than | | are high, the chance of time t |
| expected range. | | being anomalous increases. |
| Total number of issues with | \|Issuesₓ\| | It is also important to know |
| status code X at time t | | total number of issues grouped |
| | | by status code, to avoid bias |
| | | towards one status code. |
| Median difference from all | Medₓ(\|Obs_valₓ − | If the median/ maximum |
| the issues between observed | Exp_valₓ\|) | differences are high at a |
| value, and expected range, | | certain time, this is a severe |
| where X is the status code. | | anomaly compared to lower |
| Maximum difference from all | Maxₓ (\|Obs_valₓ − | differences. |
| the issues between observed | Exp_valₓ\|) | |
| value, and expected range, | | |
| where X is the status code. | | |
| Is there is an anomaly in CPU | If_CPU_Memory_Anomaly | True/ False |
| or memory utilization at time t | | |

For anomaly detection, the defined features may be used to train an anomaly detection model to predict anomalous time periods per log source. The probability of an anomaly from the model may be used to compute the severity score at this level. In particular embodiments, the severity score may be 100*(1−p(Ft)).

As illustrated in FIG. 1, the disclosed AIOps system may have an L1 level 110. At this level, all the severity scores from all the log sources may be aggregated in one place. The L1 level 110 can be helpful for the support team to understand how many log sources are impacted at the same time and get an overall understanding of severity scores to prioritize which L3 130 issues need to be investigated first.

In particular embodiments, the AIOps system may determine that at least a first severity associated with a first abnormal event among the plurality of abnormal events exceeds a threshold severity. Sending the instructions for presenting the alert to the user device may be responsive to determining at least the first severity exceeds the threshold severity.

In anomaly detection by the disclosed AIOps system, log sources can be added or removed as a plug-in without disturbing the effectiveness of the rest of the log sources.

Evaluating an anomaly detection model of the AIOps system can be challenging due to several reasons. First, there may not be a clear definition of “normal” behavior for the system under observation, making it difficult to determine what constitutes an anomaly. Second, the lack of standardized metrics for evaluating the anomaly detection model may add to the challenge. Finally, most of the applications may have a very limited number of real incidents, and it can be challenging to get a ground truth for the evaluation.

In particular embodiments, the AIOps system may identify a plurality of events associated with the plurality of logs. The AIOps system may access, for each of the identified events over a prior time period, historical data and real incidents associated with that event. The AIOps system may then determine, based on the historical data associated with each identified event, a distribution associated with that event. The AIOps system may further compare, for each of the identified events, the distribution against event values during the real incidents. The AIOps system may then estimate, for each of one or more of the identified events, a ground truth based on the comparison. The ground truth may indicate whether a corresponding event is an abnormal event or a non-abnormal event. In particular embodiments, the AIOps system may evaluate the one or more machine-learning models based on the estimated ground truth associated with each of the identified events.

In particular embodiments, estimating the ground truth for each of the one or more of the identified events based on the comparison may include the following operations. The AIOps system may determine a median value of the distribution. The AIOps system may then estimate the ground truth for each of the one or more of the identified events as a non-abnormal event when the corresponding event value is lesser than the median value. The AIOps system may also identify a predetermined percentile from the distribution. The predetermined percentile may be greater than a percentile determined based on the median value. The AIOps system may further estimate the ground truth for each of the one or more of the identified events as an abnormal event when the corresponding event value is greater than an observed value corresponding to the predetermined percentile. Estimating ground truth from existing data distributions and historical incidents may be an effective solution for addressing the technical challenge of obtaining ground truth that categorizes anomalous versus non-anomalous events to quantify the performance of the AIOps system as historical data distribution of each event is observed and compared against the values during the real-incident history, thereby providing a statistical technique to estimate ground truth.

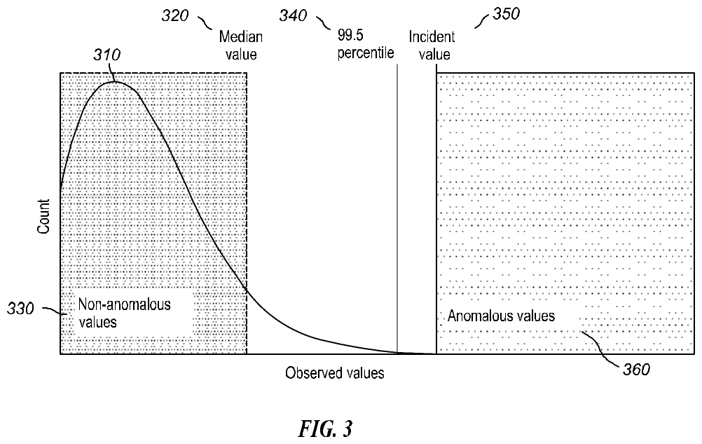

FIG. 3 illustrates an example estimation of ground truth. These ground truth values can be used to compute the sensitivity and specificity of the anomaly detection model at the L3 (event) level 130.

To estimate the ground truth, the historical data distribution 310 of each event may be observed and compared against the values during the real-incident history. These real incidents could be due to planned/unplanned outages, incidents during deployment, customer-reported incidents, etc.

For log sources such as infrastructure metrics, the event could be device utilization, memory availability, etc. For access logs, the below operations may be executed to estimate ground truth. In particular embodiments, the AIOps system may consider N number of months to identify the data distribution for each event [HTTP_Status, API_Action, HTTP_Method]. Let X denote the distribution.

The AIOps system may then obtain the median value 320 (i.e., percentile(p) 50) of the distribution: p(50)=median(X). This statistic can be modified to a lower p value if the cloud application has a greater number of incidents. For most of the stable applications, a median(X) value observation may happen during non-anomalous time periods 330. Therefore, an anomaly negative case may be when the event value is lesser than the median(X).

The AIOps system may further obtain the 99.5 percentile (p(99.5)) 340 from the distribution 310. Let the observed event value during an incident(s) (i.e., incident value 350) be x_{inc_1}, x_{inc_2}, . . . x_{inc_i}, where inc_i is the i-th incident. The AIOps system may identify the incident with the least value, e.g., denoted as x_{inc}. If p(99.5)<x_{inc}, there may be a high probability that the event is impacted due to the incident. Therefore, an anomaly positive 360 may happen when an event value is greater than x_{inc}.

In particular embodiments, estimation of the ground truth can be updated on a regular basis based on change in data distribution, expansion of application, planned outage, or a real incident. For instance, there could be API services added to or removed from the application, which could potentially alter the distribution of the data. The estimation of ground truth can be re-run with every observed change in the application.

Due to the unsupervised nature of the data, gathering ground truth of the L2 level 120 can be challenging. In particular embodiments, the severity score thresholds can be adjusted based on input from the operations to ensure critical incidents are not missed out by the anomaly detection model of the AIOps system.

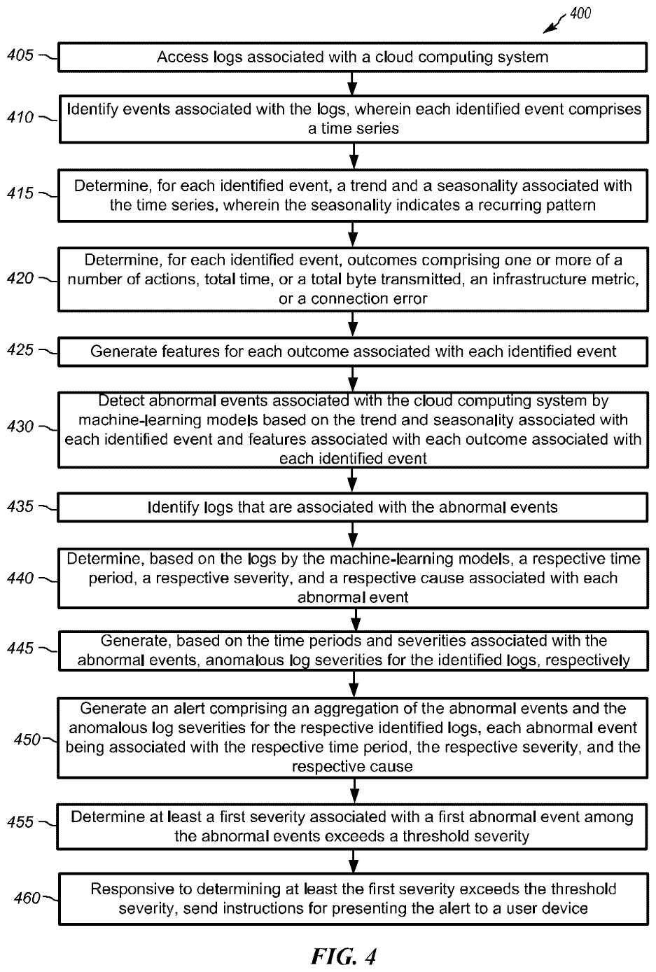

FIG. 4 illustrates is a flow diagram of a method 400 for anomaly detection in a cloud computing system, in accordance with the presently disclosed embodiments. The method 400 may be performed utilizing one or more processing devices (e.g., an AIOps system) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing wireless communication data, software (e.g., instructions running/executing on one or more processors), firmware (e.g., microcode), or some combination thereof.

The method 400 may begin at step 405 with the one or more processing devices (e.g., the AIOps system). For example, in particular embodiments, the AIOps system may access logs associated with a cloud computing system. The method 400 may then continue at step 410 with the one or more processing devices (e.g., the AIOps system). For example, in particular embodiments, the AIOps system may identify events associated with the logs, wherein each identified event comprises a time series. The method 400 may then continue at step 415 with the one or more processing devices (e.g., the AIOps system). For example, in particular embodiments, the AIOps system may determine, for each identified event, a trend and a seasonality associated with the time series, wherein the seasonality indicates a recurring pattern. The method 400 may then continue at step 420 with the one or more processing devices (e.g., the AIOps system). For example, in particular embodiments, the AIOps system may determine, for each identified event, outcomes comprising one or more of a number of actions, total time, or a total byte transmitted, an infrastructure metric, or a connection error. The method 400 may then continue at step 425 with the one or more processing devices (e.g., the AIOps system). For example, in particular embodiments, the AIOps system may generate features for each outcome associated with each identified event. The method 400 may then continue at step 430 with the one or more processing devices (e.g., the AIOps system). For example, in particular embodiments, the AIOps system may detect abnormal events associated with the cloud computing system by machine-learning models based on the trend and seasonality associated with each identified event and features associated with each outcome associated with each identified event. The method 400 may then continue at step 435 with the one or more processing devices (e.g., the AIOps system). For example, in particular embodiments, the AIOps system may identify logs that are associated with the abnormal events. The method 400 may then continue at step 440 with the one or more processing devices (e.g., the AIOps system). For example, in particular embodiments, the AIOps system may determine, based on the logs by the machine-learning models, a respective time period, a respective severity, and a respective cause associated with each abnormal event. The method 400 may then continue at step 445 with the one or more processing devices (e.g., the AIOps system). For example, in particular embodiments, the AIOps system may generate, based on the time periods and severities associated with the abnormal events, anomalous log severities for the identified logs, respectively. The method 400 may then continue at step 450 with the one or more processing devices (e.g., the AIOps system). For example, in particular embodiments, the AIOps system may generate an alert comprising an aggregation of the abnormal events and the anomalous log severities for the respective identified logs, each abnormal event being associated with the respective time period, the respective severity, and the respective cause. The method 400 may then continue at step 455 with the one or more processing devices (e.g., the AIOps system). For example, in particular embodiments, the AIOps system may determine at least a first severity associated with a first abnormal event among the abnormal events exceeds a threshold severity. The method 400 may then continue at step 460 with the one or more processing devices (e.g., the AIOps system). For example, in particular embodiments, the AIOps system may, responsive to determining at least the first severity exceeds the threshold severity, send instructions for presenting the alert to a user device. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for anomaly detection in a cloud computing system including the particular steps of the method of FIG. 4, this disclosure contemplates any suitable method for anomaly detection in a cloud computing system including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

### Systems and Methods

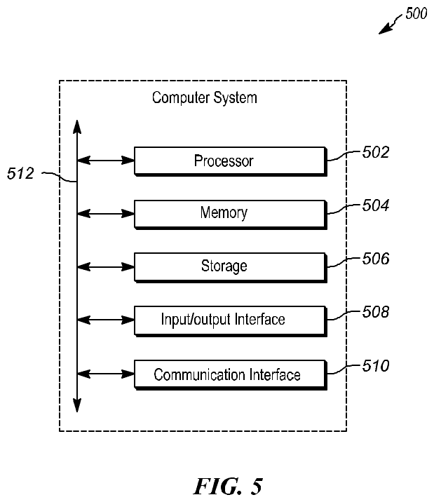

FIG. 5 illustrates an example computer system 500 that may be utilized for determining sensing and communication precoders, in accordance with the presently disclosed embodiments. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks.

Where appropriate, one or more computer systems 500 may perform without substantial spatial or temporal limitation one or more steps of one or more methods described or illustrated herein. As an example, and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement. In particular embodiments, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502.

Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example, and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere).

One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memory devices, where appropriate. Although this disclosure describes and illustrates particular memory, this disclosure contemplates any suitable memory.

In particular embodiments, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it.

As an example, and not by way of limitation, computer system 500 may communicate with an ad hoc network, a personal area network (PAN), a local area network (LAN), a wide area network (WAN), a metropolitan area network (MAN), an ultra-wideband network (UWB), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example, and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing a plurality of logs associated with a cloud computing system;
detecting, based on the plurality of logs by one or more machine-learning models, a plurality of abnormal events associated with the cloud computing system;
identifying one or more logs among the plurality of logs that are associated with the plurality of abnormal events;
determining, based on the one or more logs by the one or more machine-learning models, a respective time period and a respective severity associated with each of the plurality of abnormal events;
generating an alert comprising an aggregation of the plurality of abnormal events, each abnormal event being associated with the respective time period and the respective severity; and
sending, to a user device, instructions for presenting the alert.

2. The method of claim 1, further comprising:
determining, based on the identified logs by the machine-learning models, a respective cause associated with each abnormal event, wherein the alert further comprises the respective cause associated with each abnormal event.

3. The method of claim 1, further comprising:
identifying a plurality of events associated with the plurality of logs, wherein each of the identified events comprises a time series; and
determining, for each of the identified events, a trend and a seasonality associated with the time series, wherein the seasonality indicates a recurring pattern;
wherein detecting the plurality of abnormal events is further based on the trend and seasonality associated with each of the identified events.

4. The method of claim 1, further comprising:
identifying a plurality of events associated with the plurality of logs;
determining, for each of the identified events, one or more outcomes comprising one or more of a number of actions, total time, or a total byte transmitted, an infrastructure metric, or a connection error; and
generating a plurality of features for each of the outcomes associated with each identified event;
wherein detecting the plurality of abnormal events is further based on the plurality of features associated with each of the outcomes associated with each identified event.

5. The method of claim 1, further comprising:
generating, based on the time periods and severities associated with the plurality of abnormal events, one or more anomalous log severities for the one or more logs, respectively, wherein the alert further comprises the one or more anomalous log severities for the one or more logs, respectively.

6. The method of claim 1, further comprising:
identifying a plurality of events associated with the plurality of logs;
accessing, for each of the identified events over a prior time period, historical data and real incidents associated with that event;
determining, based on the historical data associated with each identified event, a distribution associated with that event;
comparing, for each of the identified events, the distribution against event values during the real incidents;
estimating, for each of one or more of the identified events, a ground truth based on the comparison, wherein the ground truth indicates whether a corresponding event is an abnormal event or a non-abnormal event; and
evaluating the one or more machine-learning models based on the estimated ground truth associated with each of the identified events.

7. The method of claim 6, wherein estimating the ground truth for each of the one or more of the identified events based on the comparison comprises:
determining a median value of the distribution;
estimating the ground truth for each of the one or more of the identified events as a non-abnormal event when the corresponding event value is lesser than the median value;
identifying a predetermined percentile from the distribution, wherein the predetermined percentile is greater than a percentile determined based on the median value; and
estimating the ground truth for each of the one or more of the identified events as an abnormal event when the corresponding event value is greater than an observed value corresponding to the predetermined percentile.

8. The method of claim 1, further comprising:
determining that at least a first severity associated with a first abnormal event among the plurality of abnormal events exceeds a threshold severity, wherein sending the instructions for presenting the alert to the user device is responsive to determining at least the first severity exceeds the threshold severity.

9. A computing system comprising:
one or more non-transitory computer-readable storage media including instructions; and
one or more processors coupled to the storage media, the one or more processors configured to execute the instructions to:
access a plurality of logs associated with a cloud computing system;
detect, based on the plurality of logs by one or more machine-learning models, a plurality of abnormal events associated with the cloud computing system;
identify one or more logs among the plurality of logs that are associated with the plurality of abnormal events;
determine, based on the one or more logs by the one or more machine-learning models, a respective time period and a respective severity associated with each of the plurality of abnormal events;
generate an alert comprising an aggregation of the plurality of abnormal events, each abnormal event being associated with the respective time period and the respective severity; and
send, to a user device, instructions for presenting the alert.

10. The system of claim 9, wherein the processors are further operable when executing the instructions to:
determine, based on the identified logs by the machine-learning models, a respective cause associated with each abnormal event, wherein the alert further comprises the respective cause associated with each abnormal event.

11. The system of claim 9, wherein the processors are further operable when executing the instructions to:
identify a plurality of events associated with the plurality of logs, wherein each of the identified events comprises a time series; and
determine, for each of the identified events, a trend and a seasonality associated with the time series, wherein the seasonality indicates a recurring pattern;
wherein detecting the plurality of abnormal events is further based on the trend and seasonality associated with each of the identified events.

12. The system of claim 9, wherein the processors are further operable when executing the instructions to:
identify a plurality of events associated with the plurality of logs;
determine, for each of the identified events, one or more outcomes comprising one or more of a number of actions, total time, or a total byte transmitted, an infrastructure metric, or a connection error; and
generate a plurality of features for each of the outcomes associated with each identified event;
wherein detecting the plurality of abnormal events is further based on the plurality of features associated with each of the outcomes associated with each identified event.

13. The system of claim 9, wherein the processors are further operable when executing the instructions to:
generate, based on the time periods and severities associated with the plurality of abnormal events, one or more anomalous log severities for the one or more logs, respectively, wherein the alert further comprises the one or more anomalous log severities for the one or more logs, respectively.

14. The system of claim 9, wherein the processors are further operable when executing the instructions to:
identify a plurality of events associated with the plurality of logs;
access, for each of the identified events over a prior time period, historical data and real incidents associated with that event;
determine, based on the historical data associated with each identified event, a distribution associated with that event;
compare, for each of the identified events, the distribution against event values during the real incidents;
estimate, for each of one or more of the identified events, a ground truth based on the comparison, wherein the ground truth indicates whether a corresponding event is an abnormal event or a non-abnormal event; and
evaluate the one or more machine-learning models based on the estimated ground truth associated with each of the identified events.

15. A computer-readable non-transitory storage media comprising instructions executable by a processor associated with a computing system to:
access a plurality of logs associated with a cloud computing system;
detect, based on the plurality of logs by one or more machine-learning models, a plurality of abnormal events associated with the cloud computing system;
identify one or more logs among the plurality of logs that are associated with the plurality of abnormal events;
determine, based on the one or more logs by the one or more machine-learning models, a respective time period and a respective severity associated with each of the plurality of abnormal events;
generate an alert comprising an aggregation of the plurality of abnormal events, each abnormal event being associated with the respective time period and the respective severity; and
send, to a user device, instructions for presenting the alert.

16. The media of claim 15, wherein the software is further operable when executed to:
determine, based on the identified logs by the machine-learning models, a respective cause associated with each abnormal event, wherein the alert further comprises the respective cause associated with each abnormal event.

17. The media of claim 15, wherein the software is further operable when executed to:
identify a plurality of events associated with the plurality of logs, wherein each of the identified events comprises a time series; and
determine, for each of the identified events, a trend and a seasonality associated with the time series, wherein the seasonality indicates a recurring pattern;
wherein detecting the plurality of abnormal events is further based on the trend and seasonality associated with each of the identified events.

18. The media of claim 15, wherein the software is further operable when executed to:
identify a plurality of events associated with the plurality of logs;
determine, for each of the identified events, one or more outcomes comprising one or more of a number of actions, total time, or a total byte transmitted, an infrastructure metric, or a connection error; and
generate a plurality of features for each of the outcomes associated with each identified event;
wherein detecting the plurality of abnormal events is further based on the plurality of features associated with each of the outcomes associated with each identified event.

19. The media of claim 15, wherein the software is further operable when executed to:
generate, based on the time periods and severities associated with the plurality of abnormal events, one or more anomalous log severities for the one or more logs, respectively, wherein the alert further comprises the one or more anomalous log severities for the one or more logs, respectively.

20. The media of claim 15, wherein the software is further operable when executed to:
identify a plurality of events associated with the plurality of logs;
access, for each of the identified events over a prior time period, historical data and real incidents associated with that event;
determine, based on the historical data associated with each identified event, a distribution associated with that event;
compare, for each of the identified events, the distribution against event values during the real incidents;
estimate, for each of one or more of the identified events, a ground truth based on the comparison, wherein the ground truth indicates whether a corresponding event is an abnormal event or a non-abnormal event; and
evaluate the one or more machine-learning models based on the estimated ground truth associated with each of the identified events.
